(19) United States
(12) Patent Application Publication
(10) Pub. No.: US 2024/0276951 A1
(43) Pub. Date: Aug. 22, 2024

(54) Combined Brush and Comb

(71) Applicant: Pronix Industries Incorporation, Taichung City (TW)

(72) Inventor: Yu Wen Liao, Taichung City (TW)

(21) Appl. No.: 18/172,463

(22) Filed: Feb. 22, 2023

(51) Int. Cl. A01K 13/00; A45D 24/04

(52) U.S. Cl. CPC A01K 13/002; A45D 24/04; A46B 2200/102; A46B 2200/1093

(57) ABSTRACT

A combined brush and comb contains a body, a fixing cushion, multiple bristle sets, and multiple spherical needles. The fixing cushion is disposed on the body and includes multiple receiving notches and multiple through orifices. A respective one receiving notch includes an opening defined on a top thereof, and the respective one receiving notch includes a bottom face formed on a bottom thereof. A diameter of the respective one receiving notch increases from the opening to the bottom face. The multiple bristle sets are fixed in the multiple receiving notches. The multiple spherical needles are mounted in the multiple through orifices. A respective one spherical needle includes an inverted H-shaped base, and the inverted H-shaped base has a first engagement section, a second engagement extension parallel to and spaced from the first engagement extension, and a trench defined between the first engagement extension and the second engagement extension.

### TECHNICAL FIELD

The present disclosure relates to a combined brush and comb which is capable of combing the pet's furs by using the brushing bristles made of the flexible material(s), and the combined brush and comb is capable of brushing the pet's furs and messaging the pet by using the multiple spherical needles simultaneously, thus enhancing using functions.

### BACKGROUND

For the life of modern people, it is a very popular activity to increase the joy of life by raising pets, and many people who keep pets know that cats and dogs will molt in spring and autumn, and a large amount of hair will fall out at this time. A large amount of shed hair will be attached to various objects and human bodies in the room, affecting indoor hygiene. If it is eaten by mistake, it will also affect digestion. Therefore, it is necessary to comb the hair of pets frequently, which can not only remove the shed hair dirt and dust, prevent hair tangles, but also promote blood circulation, enhance skin resistance, and relieve fatigue.

The combs currently used to comb pet hair have only a single function, such as combs with relatively soft needles or combs with relatively hard needles. A comb with softer needles can only comb the pet's shallower hair; a comb with harder needles can only roughly comb the pet's hair, and can also go deep into the hair to treat the pet's body. massage. Therefore, the actions of brushing and combing cannot be handled at the same time, resulting in a longer time for pet grooming.

The present invention has arisen to mitigate and/or obviate the afore-described disadvantages.

### SUMMARY

A primary aspect of the present invention is to provide a combined brush and comb which is capable of combing the pet's furs by using the brushing bristles made of the flexible material(s), and the combined brush and comb is capable of brushing the pet's furs and messaging the pet by using the multiple spherical needles simultaneously, thus enhancing using functions.

To obtain above-mentioned aspect, a combined brush and comb provided by the present invention contains: a body, a fixing cushion disposed on a predetermined position of the body, multiple bristle sets, and multiple spherical needles. The fixing cushion includes multiple receiving notches and multiple through orifices. A respective one receiving notch of the multiple receiving notches includes an opening defined on a top thereof, and the respective one receiving notch includes a bottom face formed on a bottom thereof. A diameter of the respective one receiving notch increases from the opening to the bottom face of the respective one receiving notch. The multiple bristle sets are fixed in the multiple receiving notches, and the multiple spherical needles are mounted in the multiple through orifices. A respective one spherical needle includes an inverted H-shaped base, and the inverted H-shaped base has a first engagement section, a second engagement extension parallel to and spaced from the first engagement extension, and a trench defined between the first engagement extension and the second engagement extension. The respective one spherical needle is received in a respective one through orifice, the first engagement extension and the second engagement extension of the inverted H-shaped base of the respective one spherical needle engage the fixing cushion, and the fixing cushion is disposed in the trench.

Preferably, a profile of the fixing cushion is oval.

Preferably, the multiple receiving notches are defined in multiple first ellipse shape, the multiple first ellipse shapes are spaced, and distances between two opposite sides of each first ellipse shape are decreased gradually from the two opposite sides of a central section of each first ellipse shape.

Preferably, the multiple through orifices are defined in multiple second ellipse shape and a linear shape, the linear shape is formed centrally and is intersected with the central section of each first ellipse shape of the fixing cushion, wherein the multiple second ellipse shapes are spaced, and distances between two opposite sides of each second ellipse shape are decreased gradually from the two opposite sides of a central section of each second ellipse shape, wherein each first ellipse shape is defined between any two adjacent second ellipse shapes.

Preferably, the fixing cushion is made of flexible material(s).

Preferably, the multiple bristle sets are made of plastic material(s).

Preferably, the spherical needles are made of metal material(s).

Preferably, the body includes an oval peripheral portion and a grip, the fixing cushion is disposed on the oval peripheral portion of the body, and the oval peripheral is the portion predetermined position of the body.

Preferably, a respective one bristle set of the multiple bristle sets includes multiple brushing bristles, the respective one bristle set is fixed in the opening of the respective one receiving notch, wherein the respective one bristle set includes a curved section which is fixed in the opening of the respective one receiving notch, and the curved section abuts against a bottom face of the respective one receiving notch.

Preferably, the body is made of wood.

Other objects and features will be in part apparent and in part pointed out hereinafter.

### BRIEF DESCRIPTION OF THE DRAWINGS

FIG. 1 is a perspective view showing the exploded components of a combined brush and comb according to a preferred embodiment of the present invention.

FIG. 2 is a perspective view showing the assembly of the combined brush and comb according to the preferred embodiment of the present invention.

FIG. 3 is a cross sectional view showing the assembly of the combined brush and comb according to the preferred embodiment of the present invention.

FIG. 4 is a top plan view showing the assembly of the combined brush and comb according to the preferred embodiment of the present invention.

FIG. 5 is an amplified cross-sectional view showing a part of the assembly of the combined brush and comb according to the preferred embodiment of the present invention.

### DETAILED DESCRIPTION

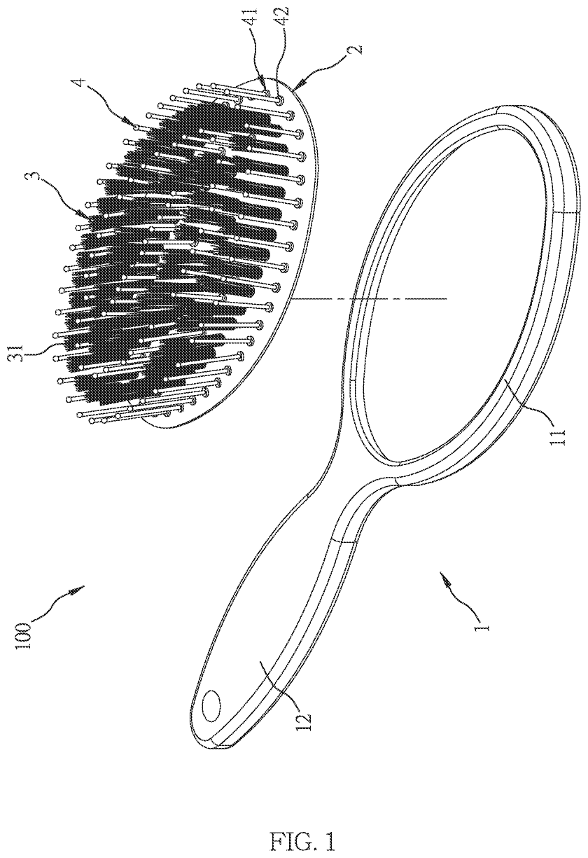

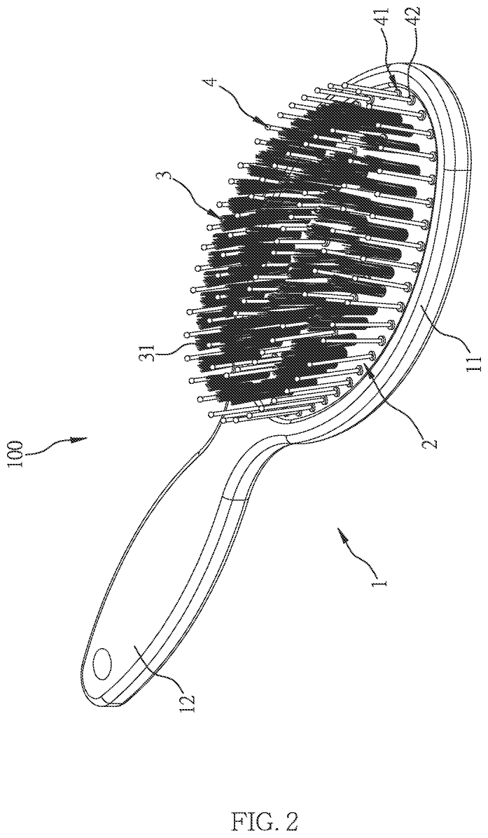

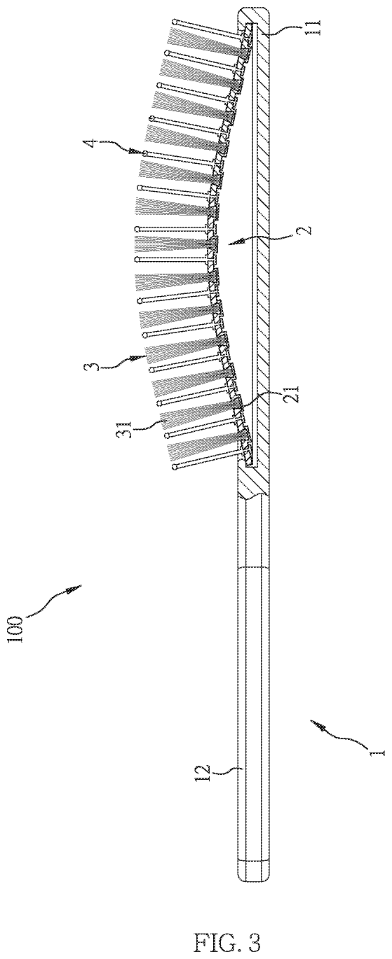

With reference to FIGS. 1-4, a combined brush and comb 100 according to a preferred embodiment of the present invention comprises: a body 1, a fixing cushion 2 made of flexible material(s), multiple bristle sets 3, and multiple spherical needles 4.

Referring to FIG. 1, the body 1 includes an oval peripheral portion 11 and a grip 12, and the fixing cushion 2 is disposed on the oval peripheral portion 11 of the body 1. The body 1 is made of rigid material which is wood or other materials.

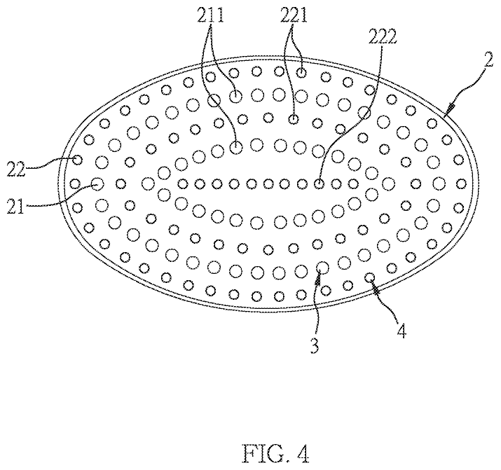

As shown in FIGS. 1 and 4, the fixing cushion 2 is disposed on a predetermined position of the body 1, wherein the predetermined position of the body 1 is the oval peripheral portion 11. The fixing cushion 2 includes multiple receiving notches 21 and multiple through orifices 22, wherein a profile of the fixing cushion 2 is oval to corresponds to the oval peripheral portion 11 of the body 1.

As illustrated in FIG. 4, wherein the multiple receiving notches 21 are defined in multiple first ellipse shape 211, the multiple first ellipse shapes 211 are spaced, and distances between two opposite sides of each first ellipse shape 211 are decreased gradually from the two opposite sides of a central section of each first ellipse shape 211.

With reference to FIG. 4, the multiple through orifices 22 are defined in multiple second ellipse shape 221 and a linear shape 222. The linear shape 222 is formed centrally and is intersected with the central section of each first ellipse shape 211 of the fixing cushion 2, wherein the multiple second ellipse shapes 221 are spaced, and distances between two opposite sides of each second ellipse shape 221 are decreased gradually from the two opposite sides of a central section of each second ellipse shape 221. Each first ellipse shape 211 is defined between any two adjacent second ellipse shapes 221.

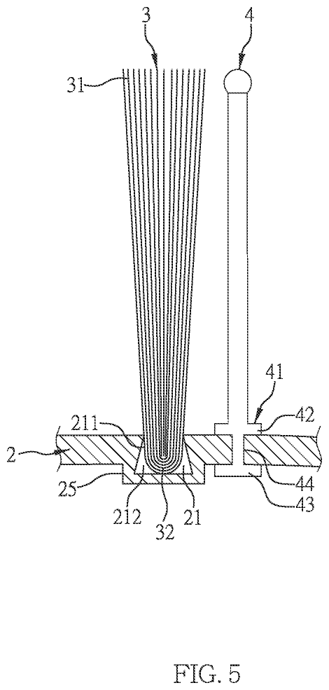

Referring further to FIGS. 1-5, the multiple bristle sets 3 are fixed in the multiple receiving notches 21, wherein a respective one receiving notch 21 of the multiple receiving notches 21 includes an opening 212 formed on a top of the respective one receiving notch 21, and the opening 212 of the respective one receiving notch 21 includes a first area formed on a top of the opening 212, and the opening 212 has a second area formed on a bottom thereof and more than the first area of the top of the opening 212. In other words, a diameter of the respective one receiving notch 21 increases from the top of the respective one receiving notch 21 to the bottom of the respective one receiving notch 21. A respective one bristle set 3 of the multiple bristle sets 3 includes multiple brushing bristles 31. The multiple bristle sets 3 are made of flexible material(s), such as plastic material(s). With reference to FIG. 5, the respective one bristle set 3 is fixed in the opening 212 of the respective one receiving notch 21, wherein the respective one bristle set 3 includes a curved section 32 which is fixed in the opening 212 of the respective one receiving notch 21, and the curved section 32 abuts against a bottom face 213 of the respective one receiving notch 21.

Referring further to FIGS. 1-5, the multiple spherical needles 4 are mounted in the multiple through orifices 22, wherein the spherical needles 4 are made of metal material(s), such as stainless steel. As shown in FIG. 5, a respective one spherical needle 4 includes an inverted H-shaped base 41, and the inverted H-shaped base 41 has a first engagement section 42, a second engagement extension 43 parallel to and spaced from the first engagement extension 42, and a trench 44 defined between the first engagement extension 42 and the second engagement extension 43, such that the respective one spherical needle 4 is received in a respective one through orifice 22, the first engagement extension 42 and the second engagement extension 43 of the inverted H-shaped base 41 of the respective one spherical needle 4 engage the fixing cushion 2, and the fixing cushion 2 is disposed in the trench 44. A height of the trench 44 is equal to a thickness of the fixing cushion 2.

Thereby, the combined brush and comb 100 is capable of brushing and combing the pet's furs and massaging the pet simultaneously.

The combined brush and comb 100 is capable of combing the pet's furs by using the brushing bristles 31 made of the flexible material(s), and the combined brush and comb 100 is capable of brushing the pet's furs and messaging the pet by using the multiple spherical needles 4 simultaneously, thus enhancing using functions.

Having described the invention in detail, it will be apparent that modifications and variations are possible without departing from the scope of the invention defined in the appended claims.

When introducing elements of the present invention or the preferred embodiments thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above constructions, products, and methods without departing from the scope of the invention, it is intended that all matter contained in the above description and shown in the accompanying drawings shall be interpreted as illustrative and not in a limiting sense.

1. A combined brush and comb comprising:
a body;
a fixing cushion disposed on a predetermined position of the body, wherein the fixing cushion includes multiple receiving notches and multiple through orifices, wherein a respective one receiving notch of the multiple receiving notches includes an opening defined on a top of the respective one receiving notch, and the respective one receiving notch includes a bottom face formed on a bottom thereof, wherein a diameter of the respective one receiving notch increases from the opening to the bottom face of the respective one receiving notch;
multiple bristle sets fixed in the multiple receiving notches; and
multiple spherical needles mounted in the multiple through orifices, wherein a respective one spherical needle includes an inverted H-shaped base, and the inverted H-shaped base has a first engagement section, a second engagement extension parallel to and spaced from the first engagement extension, and a trench defined between the first engagement extension and the second engagement extension;
wherein the respective one spherical needle is received in a respective one through orifice, the first engagement extension and the second engagement extension of the inverted H-shaped base of the respective one spherical needle engage the fixing cushion, and the fixing cushion is disposed in the trench;
wherein a profile of the fixing cushion is oval;
wherein the multiple receiving notches are defined in multiple first ellipse shapes, the multiple first ellipse shapes are spaced, and distances between two opposite sides of each first ellipse shape are decreased gradually from the two opposite sides of a central section of each first ellipse shape;
wherein the multiple through orifices are defined in multiple second ellipse shapes and a linear shape, the linear shape is formed centrally and is intersected with the central section of each first ellipse shape of the fixing cushion, wherein the multiple second ellipse shapes are spaced, and distances between two opposite sides of each second ellipse shape are decreased gradually from the two opposite sides of a central section of each second ellipse shape, wherein each first ellipse shape is defined between any two adjacent second ellipse shapes;
wherein the opening of the respective one receiving notch includes a first area formed on a top of the opening, and the opening has a second area formed on a bottom thereof and more than the first area of the top of the opening; and
wherein a diameter of the respective one receiving notch increases from the top of the respective one receiving notch to the bottom of the respective one receiving notch.

2. (canceled)

3. (canceled)

4. (canceled)

5. The combined brush and comb as claimed in claim 1, wherein the fixing cushion is made of flexible material(s).

6. The combined brush and comb as claimed in claim 1, wherein the multiple bristle sets are made of plastic material(s).

7. The combined brush and comb as claimed in claim 1, wherein the spherical needles are made of metal material(s).

8. The combined brush and comb as claimed in claim 1, wherein the body includes an oval peripheral portion and a grip, the fixing cushion is disposed on the oval peripheral portion of the body, and the oval peripheral is the portion predetermined position of the body.

9. The combined brush and comb as claimed in claim 1, wherein a respective one bristle set of the multiple bristle sets includes multiple brushing bristles, the respective one bristle set is fixed in the opening of the respective one receiving notch, wherein the respective one bristle set includes a curved section which is fixed in the opening of the respective one receiving notch, and the curved section abuts against a bottom face of the respective one receiving notch.

10. The combined brush and comb as claimed in claim 1, wherein the body is made of wood.
